(19) United States
(12) Patent Application Publication
(10) Pub. No.: US 2008/0259095 A1
(43) Pub. Date: Oct. 23, 2008

(54) Method and Apparatus for Changing Display Orientations on a Monitor of a Portable Computer

(76) Inventors: Justin T. Dubs, Durham, NC (US); James J. Thrasher, Efland, NC (US); Jennifer G. Zawacki, Hillsborough, NC (US)

Correspondence Address: DILLON & YUDELL LLP, 8911 N. CAPITAL OF TEXAS HWY, SUITE 2110, AUSTIN, TX, 78759, US

(21) Appl. No.: 11/736,070

(22) Filed: Apr. 17, 2007

(51) Int. Cl. G09G 5/00

(52) U.S. Cl. 345/659

(57) ABSTRACT

A method for changing the display orientation on a monitor of a portable computer after the portable computer has been rotated by a user is disclosed. In response to a detection that the portable computer has been physically rotated, a determination is made whether or not the new physical orientation is unchanged within a predetermined period of time. If the new physical orientation has been changed within the predetermined period of time, the portable computer continues to detect for a physical rotation. If the new physical orientation is unchanged within the predetermined period of time, a display orientation on a monitor of the portable computer is adjusted to accommodate the new physical orientation.

### BACKGROUND OF THE INVENTION

1. Technical Field

The present invention relates to portable computers in general, and, in particular, to portable computers capable of changing display orientation. Still more particularly, the present invention relates to a method and apparatus for changing the display orientation on a monitor of a portable computer after the portable computer has been rotated by a user.

2. Description of Related Art

When using a portable personal computer (PC), such as a handheld PC, a tablet PC, or an ultra-mobile PC, a user often desires to physical rotate the personal PC such that the orientation of the monitor is better suit for the task at hand. For example, text documents tend to be better suited to be viewed on a monitor placed in portrait orientation, while some photographs are better suited to be viewed on a monitor placed in a landscape orientation.

Currently, a user is required to use a software interface to change the display orientation on a monitor of a portable PC after the portable PC has been physically rotated. Such solution seems to be somewhat cumbersome for spur-of-the-moment usages. Other solution for changing the display orientation on a monitor of a portable PC may include the usage of a physical button. However, with such a solution, each time the button is pressed, a user has to wait for the Windows® operating system to change the display mode and to re-align the display of all the icons, which may take many seconds.

Consequently, it would be desirable to provide an improved method and apparatus for changing the display orientation on a monitor of a portable PC after the portable PC has been physically rotated by a user.

### SUMMARY OF THE INVENTION

In accordance with a preferred embodiment of the present invention, in response to a detection that the portable computer has been physically rotated, a determination is made whether or not the new physical orientation is unchanged within a predetermined period of time. If the new physical orientation has been changed within the predetermined period of time, the portable computer continues to detect for a physical rotation. If the new physical orientation is unchanged within the predetermined period of time, a display orientation on a monitor of the portable computer is adjusted to accommodate the new physical orientation.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a portable computer in which a preferred embodiment of the present invention is incorporated;

FIG. 2 is a high-level logic flow diagram of a method for changing the display orientation on a monitor of the portable computer from FIG. 1, in accordance with a preferred embodiment of the present invention; and

FIG. 3 is a high-level logic flow diagram of a method for changing the display orientation on a monitor of the portable computer from FIG. 1, in accordance with an alternative embodiment of the present invention.

### DETAILED DESCRIPTION OF A PREFERRED EMBODIMENT

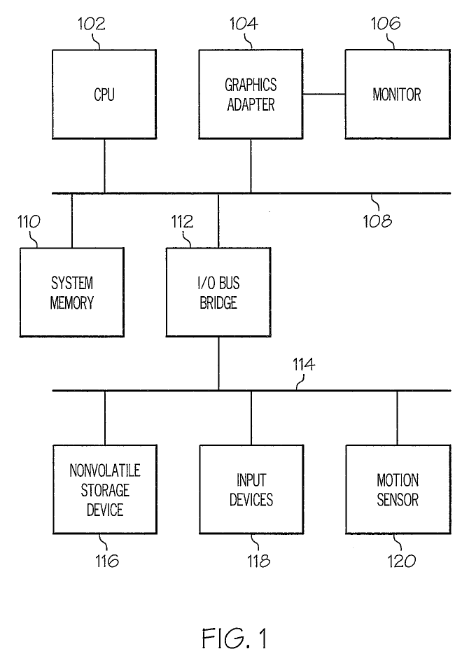

Referring now to the drawings and in particular to FIG. 1, there is depicted a block diagram of a portable computer in which a preferred embodiment of the present invention is incorporated. As shown, a portable computer 100 includes a central processing unit (CPU) 102 connected to a system bus 108. Portable computer 100 also includes a graphics adapter 104 connected to system bus 108 for providing user interface information to a monitor 106.

Also connected to system bus 108 are a system memory 110 and an input/output (I/O) bus bridge 112. I/O bus bridge 112 couples an I/O bus 114 to system bus 108 to relay and/or to transform data transactions from one bus to another. A non-volatile storage device 116, such as a hard disk drive, and input devices 118, such as a keyboard and a touch pad, are connected to I/O bus 114.

Portable computer 100 also includes a motion sensor 120. Motion sensor 120 preferably contains one or more accelerometers. When portable computer 100 is physically moved, motion sensor 120 is capable of detecting and sending signals to indicate the amount of acceleration and direction of the movement. Preferably, motion sensor 120 can provide three-dimensional movement information. For example, if a user rotates portable computer 100 90° to change the physical orientation of portable computer 100, at least two accelerometers within motion sensor 120 should be activated to send signals that, when combined, can indicate the amount of acceleration and the direction at which portable computer 100 is being rotated. These signals are preferably interpreted by CPU 102, but may be interpreted by another dedicated circuit such as an application-specific integrated circuit (ASIC) (not shown).

The chassis of portable computer 100 is preferably rectangular in shape having a relatively small thickness (i.e., the thickness is much smaller than the width and the length). Monitor 106 is also rectangular in shape with physical dimensions just smaller than that of the chassis of portable computer 100. A landscape orientation is defined as the position when the two longer sides of a rectangle provide the top and bottom of a viewing frame. A portrait orientation is defined as the position when the two shorter sides of a rectangle provide the top and bottom of a viewing frame. Both landscape and portrait orientation can be utilized to describe the position of the chassis of portable computer 100 as well as the position of monitor 106 with respect to a user who is viewing monitor 106.

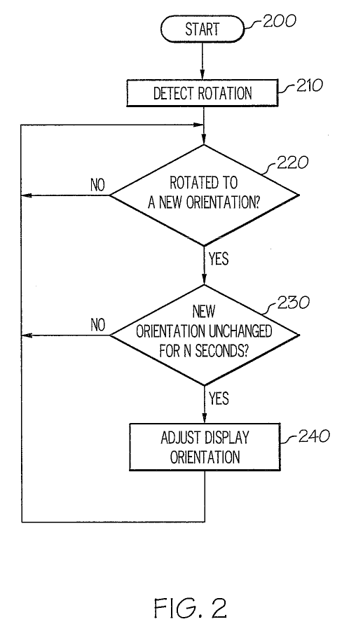

With reference now to FIG. 2, there is depicted a high-level logic flow diagram of a method for changing the display orientation on a monitor of a portable computer, in accordance with a preferred embodiment of the present invention. Starting at block 200, a motion sensor, such as motion sensor 120 from FIG. 1, is set to detect any physical rotation of a portable computer, such as portable computer 100 from FIG. 1, as shown in block 210. A determination is then made whether or not the portable computer has been rotated to a new physical orientation, as depicted in block 220. For example, the rotation may change the chassis (along with the monitor) of the portable computer from a landscape orientation to a portrait orientation or vice versa.

If the portable computer has not been rotated to a new physical orientation, then the process returns to block 220. Otherwise, if the portable computer has been rotated to a new physical orientation, another determination is made whether or not the new physical orientation is unchanged within N seconds, as depicted in block 230. N can be any number but is preferably 2.

If the new physical orientation is changed within N seconds, then the process returns to block 220. Otherwise, if the new physical orientation is unchanged within N seconds, then the display orientation on the monitor of the portable computer is adjusted to coincide with the new physical orientation, as depicted in block 240. For example, if the new physical orientation is a portrait orientation, then the display orientation on the monitor is adjusted to a portrait orientation. However, if the new physical orientation is a landscape orientation, then the display orientation on the monitor is adjusted to a landscape orientation.

In addition, the new physical orientation is also based on the tilt of portable computer. For example, if the new physical orientation is a portrait (or landscape) orientation and the monitor is facing a holder of the portable computer, then the display orientation is changed to a portrait (or landscape) orientation suitable to be viewed by the holder. However, if the new physical orientation is a portrait (or landscape) orientation and the monitor is facing away from the holder, then the display orientation is changed to a portrait (or landscape) orientation suitable to be viewed by another person (which should be a 180° rotation from the display orientation suitable to be viewed by the holder).

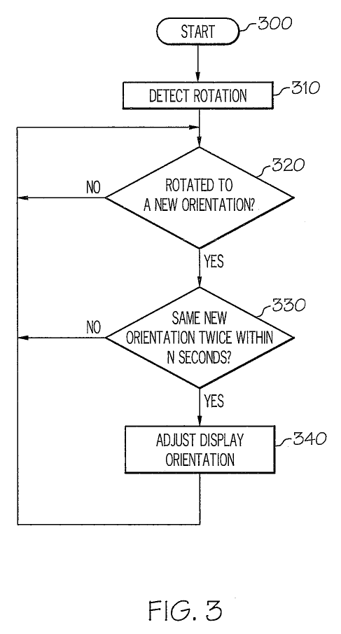

Referring now to FIG. 3, there is depicted a high-level logic flow diagram of a method for changing the display orientation on a monitor of a portable computer, in accordance with an alternative embodiment of the present invention. Starting at block 300, a motion sensor, such as motion sensor 120 from FIG. 1, is set to detect any physical rotation of a portable computer, such as portable computer 100 from FIG. 1, as shown in block 310. A determination is then made whether or not the portable computer has been rotated to a new physical orientation, as depicted in block 320. For example, the rotation may change the chassis (along with the monitor) of the portable computer from a landscape orientation to a portrait orientation or vice versa.

If the portable computer has not been rotated to a new physical orientation, then the process returns to block 320. Otherwise, if the portable computer has been rotated to a new physical orientation, another determination is made whether or not the portable computer has been placed in a same new physical orientation twice within N seconds, as shown in block 330. N can be any number but is preferably 2. A holder of portable computer can place the portable computer in the same new physical orientation twice within N seconds by rotating the portable computer to a new physical orientation for the first time, then rotates the portable computer back to its previous physical orientation, and rotates the portable computer to the same new physical orientation for the second time.

If the new physical orientation is changed within N seconds, then the process returns to block 320. Otherwise, if the portable computer has been placed in the new physical orientation twice within N seconds, then the display orientation on the monitor is adjusted to coincide with the new physical orientation, as shown in block 330. The new physical orientation is also based on the tilt of portable computer. For example, if the new physical orientation is a portrait (or landscape) orientation and the monitor is facing a holder of the portable computer, then the display orientation is changed to a portrait (or landscape) orientation suitable to be viewed by the holder. However, if the new physical orientation is a portrait (or landscape) orientation and the monitor is facing away from the holder, then the display orientation is changed to a portrait (or landscape) orientation suitable to be viewed by another person.

As has been described, the present invention provides a method and apparatus for changing the display orientation on a monitor of a portable computer after the portable computer has been rotated by a user.

It is also important to note that although the present invention has been described in the context of a fully functional computer system, those skilled in the art will appreciate that the mechanisms of the present invention are capable of being distributed as a computer program product in a variety of forms, and that the present invention applies equally regardless of the particular type of signal bearing media utilized to actually carry out the distribution. Examples of signal bearing media include, without limitation, recordable type media such as floppy disks or compact discs and transmission type media such as analog or digital communications links.

While the invention has been particularly shown and described with reference to a preferred embodiment, it will be understood by those skilled in the art that various changes in form and detail may be made therein without departing from the spirit and scope of the invention.

What is claimed is:

1. A method for changing the display orientation on a monitor of a portable computer, said method comprising:
detecting for a rotation of said portable computer;
in response to a detection of said portable computer has been rotated to a new physical orientation, determining whether or not said new physical orientation is to be intended;
in a determination that said new physical orientation is not to be intended, continue detecting for a rotation of said portable computer; and
in a determination that said new physical orientation is to be intended, adjusting a display orientation of said monitor to accommodate said new physical orientation.

2. The method of claim 1, wherein said determining further includes determining whether or not said new physical orientation is unchanged within a predetermined period of time.

3. The method of claim 1, wherein said determining further includes determining whether or not said portable computer has been placed in said new physical orientation twice within a predetermined period of time.

4. The method of claim 1, wherein said new physical orientation includes the tilt of said portable computer.

5. A computer usable medium having a computer program product for changing the display orientation on a monitor of a portable computer, said computer usable medium comprising:
computer program code for detecting for a rotation of said portable computer;
computer program code for, in response to a detection of said portable computer has been rotated to a new physical orientation, determining whether or not said new physical orientation is to be intended;
computer program code for, in a determination that said new physical orientation is not to be intended, continue detecting for a rotation of said portable computer; and
computer program code for, in a determination that said new physical orientation is to be intended, adjusting a display orientation of said monitor to accommodate said new physical orientation.

6. The computer usable medium of claim 5, wherein said computer program code for determining further includes computer program code for determining whether or not said new physical orientation is unchanged within a predetermined period of time.

7. The computer usable medium of claim 5, wherein said computer program code for determining further includes computer program code for determining whether or not said portable computer has been placed in said new physical orientation twice within a predetermined period of time.

8. The computer usable medium of claim 5, wherein said new physical orientation includes the tilt of said portable computer.

9. A portable computer capable of changing the display orientation on a monitor, said portable computer comprising:
a motion sensor for detecting for a rotation of said portable computer;
a processor for, in response to a detection of said portable computer has been rotated to a new physical orientation, determining whether or not said new physical orientation is to be intended;
a graphics adapter for, in a determination that said new physical orientation is not to be intended, continue detecting for a rotation of said portable computer; and
said graphics adapter for, in a determination that said new physical orientation is to be intended, adjusting a display orientation of said monitor to accommodate said new physical orientation.

10. The portable computer of claim 5, wherein said processor for determining further includes processor for determining whether or not said new physical orientation is unchanged within a predetermined period of time.

11. The portable computer of claim 9, wherein said processor for determining further includes processor for determining whether or not said portable computer has been placed in said new physical orientation twice within a predetermined period of time.

12. The portable computer of claim 9, wherein said new physical orientation includes the tilt of said portable computer.
